(19) United States
(12) Patent Application Publication
(10) Pub. No.: US 2026/0351838 A1
(43) Pub. Date: Nov. 5, 2026

(54) ELECTRONIC DEVICE

(71) Applicant: HUAWEI TECHNOLOGIES CO., LTD., Shenzhen (CN)

(72) Inventors: Mengruo Zou, Shanghai (CN); Bo Huang, Shanghai (CN); Chunyang Wang, Shanghai (CN); Jianhua Deng, Shanghai (CN); Shuwen LYU, Shanghai (CN)

(73) Assignee: HUAWEI TECHNOLOGIES CO., LTD., Shenzhen (CN)

(21) Appl. No.: 19/715,793

(22) Filed: Jun. 22, 2026

Related U.S. Application Data
(63) Continuation of application No. PCT/CN2024/122820, filed on Sep. 30, 2024.

(30) Foreign Application Priority Data
Dec. 22, 2023 (CN) 202311792350.1

(51) Int. Cl. H01Q 1/24; H01Q 21/28

(52) U.S. Cl. CPC H01Q 1/243; H01Q 21/28

(57) ABSTRACT

An electronic device includes a display, a middle frame, a back cover, a battery, and a first antenna. The middle frame is located between the display and the back cover and includes a connection plate and a side frame disposed around the connection plate. The connection plate is provided with a battery compartment that is configured to receive the battery, wherein an opening of the battery compartment faces the display. The first antenna is located between the connection plate and the back cover, a projection of the first antenna on the back cover along a first direction at least partially overlaps a projection of the battery on the back cover along the first direction, where the first direction is a thickness direction of the electronic device.

### CROSS-REFERENCE TO RELATED APPLICATIONS

This is a continuation of International Application No. PCT/CN2024/122820 filed on Sep. 30, 2024, which claims priority to Chinese Patent Application No. 202311792350.1 filed on Dec. 22, 2023. The disclosures of the aforementioned applications are hereby incorporated by reference in their entireties.

### TECHNICAL FIELD

Disclosed embodiments relate to the field of terminal devices, and more specifically, to an electronic device.

### BACKGROUND

As user expectations for aesthetics of electronic devices keep rising, more electronic devices with metal appearances have appeared in the market. In electronic devices (such as mobile phones), antennas are typically designed using side frames as antenna radiator. However, no antennas are deployed inside the electronic device, especially in a battery area, resulting in low antenna radio frequency performance of the electronic device.

### SUMMARY

Disclosed embodiments provide an electronic device that deploys an antenna in a battery area so that a deployment area of the antenna is increased, and antenna radio frequency performance of the electronic device is improved.

According to a first aspect, an electronic device includes a display, a middle frame, a back cover, a battery, and a first antenna, where the middle frame is located between the display and the back cover, the middle frame includes a connection plate and a side frame disposed around the connection plate, the connection plate is provided with a battery compartment, and the battery compartment is configured for placement of the battery; and a projection of the first antenna on the back cover along a first direction at least partially overlaps a projection of the battery on the back cover along the first direction, and the first direction is a thickness direction of the electronic device.

It should be understood that, in this disclosure, an antenna may be deployed in a corresponding area of the battery. That is, the projection of the first antenna on the back cover along the first direction at least partially overlaps the projection of the battery on the back cover along the first direction.

In this embodiment, considering that a range of an area of the battery is large, an antenna is deployed in the area of the battery, so that a deployment area of the antenna can be expanded, and antenna radio frequency performance of the electronic device can be improved.

With reference to the first aspect, in some implementations of the first aspect, the middle frame is a non-metal middle frame, the first antenna is located on a surface that is of the connection plate and that is away from the battery, and along the first direction, a distance between the first antenna and the battery is greater than or equal to a first threshold.

For example, the middle frame may be made of a plastic material.

For example, the first threshold may be at least 0.2 mm, that is, a clearance threshold of the antenna may be at least 0.2 mm. It should be noted that the first threshold is related to a frequency. For example, when millimeter waves are used, the first threshold may be 0.2 mm.

It should be noted that a space range at least 0.2 mm needs to be maintained between the first antenna and the battery, and the space range may be a cavity or filled with a non-metal material.

In an implementation, the first antenna is formed by disposing (applying) a copper foil, a flexible printed circuit (FPC), or a steel sheet on the surface of the non-metal middle frame and away from the battery. In other words, the copper foil, the FPC, or the steel sheet may be attached to the surface of the non-metal middle frame and that is away from the battery to form an antenna radiator.

It should be understood that the FPC antenna is foldable and may be bent into any shape, to meet a higher requirement of people for a size and a design of the electronic device. Therefore, in practice, the FPC antenna made of a liquid crystal polymer (LCP) material with a good high-frequency characteristic may be adopted.

In another implementation, the first antenna is a metal antenna formed by performing laser direct structuring (LDS), electroplating, or spray plating on the surface that is of the non-metal middle frame and that is away from the battery. In other words, a metal antenna radiator may be formed on the surface that is of the non-metal middle frame and that is away from the battery by using an LDS technology, an electroplating technology, a spraying technology, or the like.

Considering higher requirements on precision and reliability of an antenna in 5G, the LDS antenna technology has become a preferred solution for an antenna design of the electronic device (like the mobile phone). In the LDS technology, a metal antenna shape is directly plated on a formed plastic bracket through laser radiation. This technology avoids electromagnetic interference of internal components of the mobile phone, ensures a signal of the mobile phone, and also enhances space utilization of the mobile phone, so that the smartphone can still be kept thin in the 5G era.

In an implementation, an opening of the battery compartment faces the display, and the first antenna is located between the connection plate and the back cover. It should be understood that the first antenna is disposed between the connection plate and the back cover, to facilitate assembly and maintenance of the first antenna. In addition, considering that a specific distance needs to be maintained between the first antenna and the battery, the first antenna is disposed between the connection plate and the back cover, so that a thickness of the electronic device can also be reduced.

In an example, the electronic device further includes a mainboard and a secondary board; a first placement compartment and a second placement compartment are disposed on the connection plate, the battery compartment is located between the first placement compartment and the second placement compartment, the mainboard is placed (i.e., received) in the first placement compartment, and the secondary board is placed in the second placement compartment; and the first placement compartment and the second placement compartment have a same (i.e., common) opening direction, and an opening direction of the battery compartment is opposite to the opening direction of the first placement compartment and the second placement compartment. In other words, the opening of the battery compartment faces the display, and openings of the first placement compartment and the second placement compartment both face the back cover.

It should be understood that electronic elements such as a processor, a memory, a flash memory, and a sensor are integrated on the mainboard. A charging chip is generally integrated on the secondary board, and is configured to manage a power supply of the electronic device.

For example, the first placement compartment may be further placed with electronic components such as a main bracket, an antenna, and a speaker. The second placement compartment may be further placed with electronic components such as a secondary bracket, an antenna, and a speaker.

In this implementation, only the opening of the battery compartment faces the display, and the openings of the first placement compartment and the second placement compartment both face the back cover. Therefore, this facilitates check and maintenance of the electronic component when a fault occurs. In addition, the entire middle frame may be designed into a bow-shaped structure. In this way, rigidity of the middle frame and the entire electronic device can be improved, and product reliability can be improved.

In another example, the electronic device further includes a mainboard and a secondary board; a first placement compartment and a second placement compartment are disposed on the connection plate, the battery compartment is located between the first placement compartment and the second placement compartment, the mainboard is placed (i.e., received) in the first placement compartment, and the secondary board is placed in the second placement compartment; and the first placement compartment and the second placement compartment have opposite opening directions, and the first placement compartment and the battery compartment have a same (i.e., common) opening directions. In other words, openings of the battery compartment and the first placement compartment face the display, and an opening of the second placement compartment faces the back cover.

In still another example, the electronic device further includes a mainboard and a secondary board; a first placement compartment and a second placement compartment are disposed on the connection plate, the battery compartment is located between the first placement compartment and the second placement compartment, the mainboard is placed in the first placement compartment, and the secondary board is placed in the second placement compartment; and the first placement compartment and the second placement compartment have opposite opening directions, and the second placement compartment and the battery compartment have a same opening directions. In other words, openings of the battery compartment and the second placement compartment face the display, and an opening of the first placement compartment faces the back cover.

In another possible implementation, an opening of the battery compartment faces the back cover, and the first antenna is located between the battery and the back cover.

In an example, the electronic device further includes a mainboard and a secondary board; a first placement compartment and a second placement compartment are disposed on the connection plate, the battery compartment is located between the first placement compartment and the second placement compartment, the mainboard is placed in the first placement compartment, and the secondary board is placed in the second placement compartment; and the first placement compartment and the second placement compartment have a same opening direction, and an opening direction of the battery compartment is opposite to the opening direction of the first placement compartment and the second placement compartment. In other words, the opening of the battery compartment faces the back cover, and openings of the first placement compartment and the second placement compartment both face the display.

In another example, the electronic device further includes a mainboard and a secondary board; a first placement compartment and a second placement compartment are disposed on the connection plate, the battery compartment is located between the first placement compartment and the second placement compartment, the mainboard is placed in the first placement compartment, and the secondary board is placed in the second placement compartment; and the first placement compartment and the second placement compartment have opposite opening directions, and the first placement compartment and the battery compartment have a same opening directions. In other words, openings of the battery compartment and the first placement compartment face the back cover, and an opening of the second placement compartment faces the display.

In still another example, the electronic device further includes a mainboard and a secondary board; a first placement compartment and a second placement compartment are disposed on the connection plate, the battery compartment is located between the first placement compartment and the second placement compartment, the mainboard is placed (i.e., received) in the first placement compartment, and the secondary board is placed in the second placement compartment; and the first placement compartment and the second placement compartment have opposite opening directions, and the second placement compartment and the battery compartment have a same opening directions. In other words, openings of the battery compartment and the second placement compartment face the back cover, and an opening of the first placement compartment faces the display.

In some other implementations, opening directions of the first placement compartment, the second placement compartment, and the battery compartment may all be the same. In other words, openings of the first placement compartment, the second placement compartment, and the battery compartment may all face the display, or may all face the back cover. This is not limited herein.

It should be understood that this embodiment of this application provides design architectures of a plurality of electronic devices (for example, a mobile phone), to enrich a layout manner of internal components of the electronic device, and be applicable to different types of electronic devices.

It should be noted that locations of the first placement compartment, the second placement compartment, and the battery compartment are merely examples for description. In some other embodiments, the battery compartment may not be disposed between the first placement compartment and the second placement compartment, but is disposed at a location close to the side frame.

With reference to the first aspect, in some implementations of the first aspect, the first antenna extends to an area in which the mainboard is located and is connected to the mainboard, and/or the first antenna extends to an area in which the secondary board is located and is connected to the secondary board.

For example, the first antenna may extend to the first placement compartment and be connected to the mainboard located in the first placement compartment; or the first antenna may extend to the second placement compartment and be connected to the secondary board located in the second placement compartment; or one end of the first antenna may be connected to the mainboard, and the other end may be connected to the secondary board.

In some embodiments, the first antenna may be connected to the mainboard and/or the secondary board via a spring plate; or the first antenna (for example, the FPC antenna) is bendable, so that the first antenna can be connected to the mainboard and/or the secondary board. In some embodiments, a hole may be drilled in the first placement compartment, the second placement compartment, or the battery compartment, so that the first antenna can pass through the connection plate of the middle frame, to be connected to the mainboard located in the first placement compartment and/or the secondary board located in the second placement compartment.

With reference to the first aspect, in some implementations of the first aspect, the electronic device further includes a first speaker and a second speaker, the first speaker is disposed in the first placement compartment, the second speaker is disposed in the second placement compartment, and both the first placement compartment and the second placement compartment are sealed cavities.

In this implementation, the first placement compartment and the second placement compartment are set as sealed cavities, so that when the speakers in the first placement compartment and the second placement compartment play music, no strong vibration occurs, and vibration noise generated by the back cover when the electronic device plays music can be reduced.

For example, a connection opening is disposed on the first placement compartment, and the connection opening is configured to connect the first placement compartment and the battery compartment. For example, the top of the first placement compartment or a side edge of the first placement compartment is provided with the connection opening.

With reference to the first aspect, in some implementations of the first aspect, the electronic device further includes a second antenna and a third antenna, a projection of the second antenna on the back cover along the first direction at least partially overlaps a projection of the first placement compartment on the back cover along the first direction, and a projection of the third antenna on the back cover along the first direction at least partially overlaps a projection of the second placement compartment on the back cover along the first direction.

For example, the second antenna may be placed in the first placement compartment, and in this case, the second antenna may be fastened to the main bracket; and the third antenna may be placed in the second placement compartment, and in this case, the third antenna may be fastened to the secondary bracket.

In some embodiments, the second antenna and/or the third antenna may be connected to the mainboard and/or the secondary board via a spring plate; or the second antenna and/or the third antenna (for example, an FPC antenna) are/is bendable, so that the second antenna and/or the third antenna can be connected to the mainboard and/or the secondary board. In some embodiments, a hole may be drilled in the first placement compartment, the second placement compartment, or the battery compartment, so that the second antenna and/or the third antenna can pass through the connection plate of the middle frame, to be connected to the mainboard located in the first placement compartment and/or the secondary board located in the second placement compartment.

With reference to the first aspect, in some implementations of the first aspect, the side frame is a metal side frame, and the metal side frame is used as an antenna radiator. In this implementation, the side frame may be used as the metal antenna radiator.

It should be understood that, in some examples, the electronic device may not be provided with the second antenna and the third antenna, but directly use the metal side frame as an antenna radiator. In some other examples, the electronic device may use the metal side frame as an antenna radiator when the second antenna and/or the third antenna are/is disposed. This is not limited in this application.

According to a second aspect, an electronic device is provided, where the electronic device includes a display, a middle frame, a back cover, and a battery, where the middle frame is located between the display and the back cover, the middle frame includes a connection plate and a side frame disposed around the connection plate, the connection plate is provided with a battery compartment, and the battery compartment is configured for placement of the battery; and a first part of the connection plate is made of a metal material, the first part of the connection plate is an antenna radiator, a projection of the first part of the connection plate on the back cover along a first direction at least partially overlaps a projection of the battery on the back cover along the first direction, and the first direction is a thickness direction of the electronic device.

It should be understood that, in this disclosure, the connection plate corresponding to the battery may be set to a metal material, so that the connection plate made of the metal material may be directly used as the antenna radiator, and an antenna does not need to be separately disposed.

The “connection plate corresponding to the battery” may be understood as the first part of the connection plate, and the projection of the first part of the connection plate on the back cover along the first direction least partially overlaps the projection of the battery on the back cover along the first direction.

In this embodiment of this disclosure, considering that a range of an area of the battery is large, an antenna is deployed in the area of the battery, so that a deployment area of the antenna can be expanded, and antenna radio frequency performance of the electronic device can be improved.

With reference to the second aspect, in some implementations of the second aspect, along the first direction, a distance between the first part of the connection plate and the battery is greater than or equal to a first threshold, and the first direction is a thickness direction of the electronic device.

For example, the first threshold may be at least 0.2 mm, that is, a clearance threshold of the antenna may be at least 0.2 mm. It should be noted that the first threshold is related to a frequency. For example, when millimeter waves are used, the first threshold may be 0.2 mm.

It should be noted that a space range at least 0.2 mm needs to be maintained between the first part of the connection plate and the battery, and the space range may be a cavity or filled with a non-metal material.

In an implementation, the electronic device further includes a mainboard and a secondary board; a first placement compartment and a second placement compartment are disposed on the connection plate, the battery compartment is located between the first placement compartment and the second placement compartment, the mainboard is placed in the first placement compartment, and the secondary board is placed in the second placement compartment; and the first placement compartment and the second placement compartment have a same opening direction, an opening direction of the battery compartment is opposite to the opening direction of the first placement compartment and the second placement compartment, and an opening of the battery compartment faces the display. Both an opening of the first placement compartment and an opening of the second placement compartment face the back cover.

In this implementation, only the opening of the battery compartment faces the display, and the openings of the first placement compartment and the second placement compartment both face the back cover. Therefore, this facilitates check and maintenance of the electronic component when a fault occurs. In addition, the entire middle frame may be designed into a bow-shaped structure. In this way, rigidity of the middle frame and the entire electronic device can be improved, and product reliability can be improved.

In another implementation, the electronic device further includes a mainboard and a secondary board; a first placement compartment and a second placement compartment are disposed on the connection plate, the battery compartment is located between the first placement compartment and the second placement compartment, the mainboard is placed in the first placement compartment, and the secondary board is placed in the second placement compartment; and the first placement compartment and the second placement compartment have a same opening direction, an opening direction of the battery compartment is opposite to the opening direction of the first placement compartment and the second placement compartment, and an opening of the battery compartment faces the back cover. Both an opening of the first placement compartment and an opening of the second placement compartment face the display.

In another implementation, the electronic device further includes a mainboard and a secondary board; a first placement compartment and a second placement compartment are disposed on the connection plate, the battery compartment is located between the first placement compartment and the second placement compartment, the mainboard is placed in the first placement compartment, and the secondary board is placed in the second placement compartment; and the first placement compartment and the second placement compartment have opposite opening directions, the first placement compartment and the battery compartment have a same opening directions, and an opening of the battery compartment faces the display. An opening of the first placement compartment faces the display, and an opening of the second placement compartment faces the back cover.

In another implementation, the electronic device further includes a mainboard and a secondary board; a first placement compartment and a second placement compartment are disposed on the connection plate, the battery compartment is located between the first placement compartment and the second placement compartment, the mainboard is placed in the first placement compartment, and the secondary board is placed in the second placement compartment; and the first placement compartment and the second placement compartment have opposite opening directions, the first placement compartment and the battery compartment have a same opening directions, and an opening of the battery compartment faces the back cover. An opening of the first placement compartment faces the back cover, and an opening of the second placement compartment faces the display.

In another implementation, the electronic device further includes a mainboard and a secondary board; a first placement compartment and a second placement compartment are disposed on the connection plate, the battery compartment is located between the first placement compartment and the second placement compartment, the mainboard is placed in the first placement compartment, and the secondary board is placed in the second placement compartment; and the first placement compartment and the second placement compartment have opposite opening directions, the second placement compartment and the battery compartment have a same opening directions, and an opening of the battery compartment faces the display. An opening of the first placement compartment faces the back cover, and an opening of the second placement compartment faces the display.

In another implementation, the electronic device further includes a mainboard and a secondary board; a first placement compartment and a second placement compartment are disposed on the connection plate, the battery compartment is located between the first placement compartment and the second placement compartment, the mainboard is received in the first placement compartment, and the secondary board is placed in the second placement compartment; and the first placement compartment and the second placement compartment have opposite opening directions, the second placement compartment and the battery compartment have a same opening directions, and an opening of the battery compartment faces the back cover. An opening of the first placement compartment faces the display, and an opening of the second placement compartment faces the back cover.

In some other implementations, opening directions of the first placement compartment, the second placement compartment, and the battery compartment may all be the same. In other words, openings of the first placement compartment, the second placement compartment, and the battery compartment may all face the display, or may all face the back cover. This is not limited herein.

For example, the connection plate of the middle frame may be of a concave-convex structure, and concave parts or convex parts may form the first placement compartment, the second placement compartment, and the battery compartment. Generally, the first placement compartment and the second placement compartment may be formed in an area enclosed by the connection plate and the side frame, and the battery compartment may be located between the first placement compartment and the second placement compartment. In addition, the battery compartment, the first placement compartment, and the second placement compartment may be separated from each other by the connection plate.

It should be noted that locations of the first placement compartment, the second placement compartment, and the battery compartment are merely examples for description. In some other embodiments, the battery compartment may not be disposed between the first placement compartment and the second placement compartment, but is disposed at a location close to the side frame.

It should be understood that the first placement compartment may be further placed with electronic components such as a main bracket, an antenna, and a speaker. The second placement compartment may be further placed with electronic components such as a secondary bracket, an antenna, and a speaker.

It should be understood that this embodiment of this application provides design architectures of a plurality of electronic devices (for example, a mobile phone), to enrich a layout manner of internal components of the electronic device, and be applicable to different types of electronic devices.

With reference to the second aspect, in some implementations of the second aspect, the electronic device further includes a first speaker and a second speaker, the first speaker is disposed in the first placement compartment, the second speaker is disposed in the second placement compartment, and both the first placement compartment and the second placement compartment are sealed cavities.

In this implementation, the first placement compartment and the second placement compartment are set as sealed cavities, so that when the speakers in the first placement compartment and the second placement compartment play music, no strong vibration occurs, and vibration noise generated by the back cover when the electronic device plays music can be reduced.

For example, a connection opening is disposed on the first placement compartment, and the connection opening is configured to connect the first placement compartment and the battery compartment. For example, the top of the first placement compartment or a side edge of the first placement compartment is provided with the connection opening.

With reference to the second aspect, in some implementations of the second aspect, the electronic device further includes a second antenna and a third antenna, a projection of the second antenna on the back cover along the first direction at least partially overlaps a projection of the first placement compartment on the back cover along the first direction, and a projection of the third antenna on the back cover along the first direction at least partially overlaps a projection of the second placement compartment on the back cover along the first direction.

For example, the second antenna may be placed in the first placement compartment, and in this case, the second antenna may be fastened to the main bracket; and the third antenna may be placed in the second placement compartment, and in this case, the third antenna may be fastened to the secondary bracket.

In some embodiments, the second antenna and/or the third antenna may be connected to the mainboard and/or the secondary board via a spring plate; or the second antenna and/or the third antenna (for example, an FPC antenna) are/is bendable, so that the second antenna and/or the third antenna can be connected to the mainboard and/or the secondary board. In some embodiments, a hole may be drilled in the first placement compartment, the second placement compartment, or the battery compartment, so that the second antenna and/or the third antenna can pass through the connection plate of the middle frame, to be connected to the mainboard located in the first placement compartment and/or the secondary board located in the second placement compartment.

With reference to the second aspect, in some implementations of the second aspect, the side frame is a metal side frame, and the metal side frame is used as an antenna radiator. In this implementation, the side frame may be used as the metal antenna radiator.

It should be understood that, in some examples, the electronic device may not be provided with the second antenna and the third antenna, but directly use the metal side frame as an antenna radiator. In some other examples, the electronic device may use the metal side frame as an antenna radiator when the second antenna and the third antenna are disposed. This is not limited in this application.

### BRIEF DESCRIPTION OF DRAWINGS

FIG. 1 is a diagram of a structure of an electronic device according to an embodiment of this disclosure;

FIG. 2 is an exploded view of the electronic device shown in FIG. 1;

FIG. 3 is a diagram of a cross-sectional structure of an electronic device according to an embodiment of this disclosure;

FIG. 4 is a diagram of a cross-sectional structure of another electronic device according to an embodiment of this disclosure;

FIG. 5 is a diagram of a cross-sectional structure of another electronic device according to an embodiment of this disclosure;

FIG. 6 is a diagram of an assembly process of an electronic device according to an embodiment of this disclosure;

FIG. 7 is a diagram of a cross-sectional structure of another electronic device according to an embodiment of this disclosure;

FIG. 8 is a diagram of a cross-sectional structure of another electronic device according to an embodiment of this disclosure; and

FIG. 9 is a diagram of a cross-sectional structure of another electronic device according to an embodiment of this disclosure.

### DESCRIPTION OF EMBODIMENTS

The following describes technical solutions of this disclosure with reference to accompanying drawings.

In descriptions of embodiments of this disclosure, unless otherwise specified, “/” means “or”. For example, A/B may indicate A or B. In this specification, “and/or” describes only an association relationship between associated objects and indicates that three relationships may exist. For example, A and/or B may indicate the following three cases: Only A exists, both A and B exist, and only B exists.

In embodiments of this disclosure, prefix words such as “first”, “second”, “third”, and the like are merely used to distinguish between different described objects, and do not limit a location, a sequence, a priority, a quantity, content, or the like of the described object. Use of prefixes such as ordinal numbers used to distinguish the described objects in embodiments of this application does not constitute a limitation on the described objects. For descriptions of the described objects, refer to the context description in claims or embodiments, and the use of such prefixes should not constitute a redundant limitation. In addition, in the descriptions of embodiments, unless otherwise specified, “a plurality of” means two or more.

In embodiments of this disclosure, orientation or location relationships indicated by terms such as “up”, “down”, “front”, “back”, “top”, “bottom”, “inside”, “outside”, or the like are orientation or location relationships shown in the accompanying drawings, and are merely intended for ease of describing this application and simplifying descriptions, but are not intended to indicate or imply that an indicated apparatus or element needs to have a specific orientation or needs to be constructed and operated in a specific orientation. Therefore, this cannot be understood as a limitation on this application.

Reference to “some embodiments” or the like described in this specification indicates that one or more embodiments of this application include a specific feature, structure, or characteristic described with reference to embodiments. Therefore, statements such as “in some embodiments” that appear at different places in this specification do not necessarily mean reference to a same embodiment. Instead, the statements mean “one or more but not all of embodiments”, unless otherwise specifically emphasized in another manner. The terms “include”, “comprise”, “have” and their variants all mean “include but are not limited to”, unless otherwise specifically emphasized in another manner.

In this disclosure, “perpendicular” is not strictly perpendicular, but within an allowable error range. “Parallel” is not strictly parallel, but within an allowable error range.

In embodiments of this disclosure, a same reference numeral indicates a same component part or a same part or component. In embodiments of this application, for a plurality of same parts or components, only one part or component may be marked with a reference numeral as an example in the accompanying drawings. For another same part or component, the reference numeral is also applicable. In addition, dimensions and sizes of parts or components shown in the accompanying drawings are merely examples.

A coordinate system of the accompanying drawings is defined in embodiments of this application. A direction x, a direction y, and a direction z are perpendicular to each other. The direction z may be understood as a thickness direction of an electronic device, the direction y may be understood as a width direction of the electronic device, and the direction x may be understood as a length direction of the electronic device. Alternatively, the direction y may be understood as a length direction of the electronic device, and the direction x may be understood as a width direction of the electronic device. For example, in embodiments of this application, a structure of the electronic device is described by using an example in which the direction y is the length direction of the electronic device and the direction x is the width direction of the electronic device.

When an overall architecture of the electronic device (for example, a mobile phone) is designed, the overall architecture is mainly laid out based on a structure of a middle frame, and mainstream electronic devices generally adopt the following two architectures.

In a possible architecture of the electronic device, the electronic device includes a display, a middle frame, and a back cover, and a side that is of the middle frame and that faces the display may be referred to as a middle frame T surface, and a side that is of the middle frame and that faces the back cover may be referred to as a middle frame B surface. During specific assembly, the display may be assembled on the middle frame T surface, and components such as a battery, a mainboard, an antenna, a speaker, and the back cover may be assembled on the middle frame B surface. In this architecture design, a layout of all components is simple. When faults occur in the battery, the mainboard, the speaker, or the like, a backplane may be removed from the middle frame, so that internal electronic elements can be repaired or replaced. However, in this layout structure, only the back cover protects a side that is of the battery and that is close to the back cover. Therefore, the back cover needs to have a specific thickness, and a thickness of the back cover may affect a thickness of the entire device, resulting in a great thickness of the electronic device. In addition, an area, of the middle frame B surface, in which the battery is mounted cannot be used as the antenna, rigidity of the middle frame is poor, and the back cover is prone to generate vibration noise when the mobile phone plays music.

In another possible architecture of the electronic device, the electronic device includes a display, a middle frame, and a back cover, and a side that is of the middle frame and that faces the display may be referred to as a middle frame T surface, and a side that is of the middle frame and that faces the back cover may be referred to as a middle frame B surface. During specific assembly, components such as the display, a battery, a mainboard, an antenna, and a speaker may be assembled on the middle frame T surface, and the back cover may be assembled on the middle frame B surface. In this architecture design, the middle frame and the display protect internal electronic elements, enabling a thinner design and thereby reducing a thickness of the entire electronic device. However, in this layout structure, when the internal electronic elements are laid out and mounted, the display needs to be mounted after the internal electronic elements are mounted. However, when a fault occurs in the battery, the mainboard, the speaker, or the like, the display needs to be removed from the middle frame, and then the internal electronic elements can be repaired or replaced. Consequently, when the electronic device is faulty, manufacturability and repairability are poor, and costs are high. In addition, an area, of the middle frame T surface, in which the battery is mounted cannot be used as the antenna, rigidity of the middle frame is poor, and the display is prone to generate vibration noise when the mobile phone plays music.

Therefore, this disclosure provides an electronic device. A new design architecture is adopted, to increase a deployment area of an antenna, so that antenna radio frequency performance of the electronic device can be improved, rigidity of a middle frame can be improved, and further, vibration noise generated when the electronic device plays music can be reduced.

It should be noted that the electronic device in embodiments of this disclosure may include a mobile terminal like a mobile phone, a wearable device, a smartwatch, a tablet computer, an e-reader, a notebook computer, a laptop computer, a mobile computer, an augmented reality device, a virtual reality device, a handheld game console, and the like. In the following embodiments, an example in which the electronic device is the mobile phone is used for description.

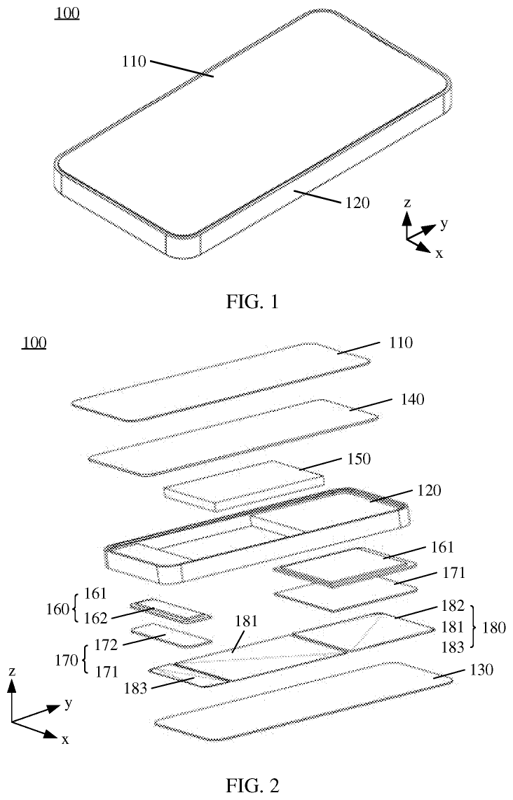

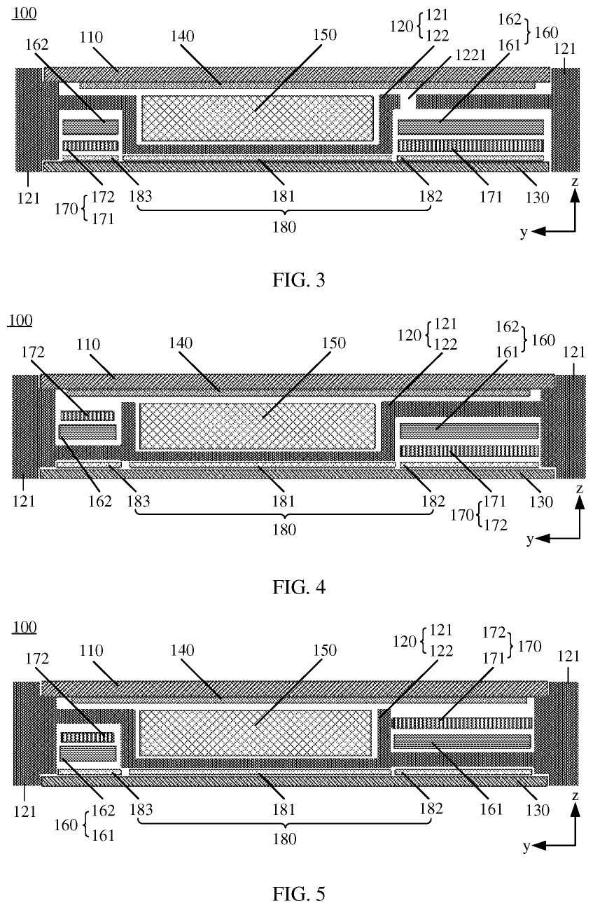

FIG. 1 is a diagram of a structure of an electronic device 100 according to an embodiment of this application. FIG. 2 is an exploded view of the electronic device 100 shown in FIG. 1. FIG. 3 is a diagram of a cross-sectional structure of the electronic device 100 shown in FIG. 1 or FIG. 2.

With reference to FIG. 1 to FIG. 3, it can be learned that the electronic device 100 may include a display 110, a middle frame 120, and a back cover 130, and the display 110 and the back cover 130 are respectively located on two sides of the middle frame 120. The middle frame 120 and the display 110 may enclose a first accommodating cavity, and the middle frame 120 and the back cover 130 may enclose a second accommodating cavity. It should be understood that the first accommodating cavity and the second accommodating cavity may accommodate some internal electronic elements of the electronic device 100, for example, components such as a heat dissipation module 140, a battery 150, a circuit board 160, a bracket 170, and an antenna 180. The heat dissipation module 140 and the battery 150 may be located in the first accommodating cavity, and the heat dissipation module 140 is attached to the display 110, and is configured to dissipate heat for the display 110. The circuit board 160, the bracket 170, and the antenna 180 may be located in the second accommodating cavity.

For example, the middle frame 120 is used as a boundary, a side that is of the middle frame 120 and that faces the display 110 may be referred to as a middle frame T surface, and a side that is of the middle frame 120 and that faces the back cover 130 may be referred to as a middle frame B surface. The heat dissipation module 140 and the battery 150 may be located in the first accommodating cavity enclosed by the middle frame T surface and the display 110; and the circuit board 160, the bracket 170, and the antenna 180 may be located in the second accommodating cavity enclosed by the middle frame B surface and the back cover 130.

In some embodiments, as shown in FIG. 3, the middle frame 120 may include a side frame 121 and a connection plate 122, the connection plate 122 is disposed in the side frame 121, and the side frame 121 is disposed around the connection plate 122. For example, the connection plate 122 may be perpendicular to the side frame 121, or the connection plate 122 and the side frame may have another included angle that is not equal to 90 degrees. The display 110 is disposed on a side of the middle frame 120, and is connected to the side frame 121 of the middle frame 120. The back cover 130 is disposed on another side of the middle frame 120, and is connected to the side frame 121 of the middle frame 120. The display 110, the middle frame 120, and the back cover 130 form a closed space, and a structure formed by the display 110, the middle frame 120, and the back cover 130 is an appearance of the electronic device 100.

The connection plate 122 is of a concave-convex structure. For example, a middle part of the connection plate 122 may be concave downward, that is, concave toward a side close to the back cover 130, to form a battery compartment. Because the connection plate 122 is connected to and inside the side frame 121, side walls on two sides of the battery compartment and the side frame 121 form a first placement compartment and a second placement compartment. The battery compartment is configured for placement of the battery 150, and the first placement compartment and the second placement compartment are configured for placement of other electronic elements, for example, the circuit board 160, the bracket 170, and the antenna 180.

It should be noted that locations of the first placement compartment, the second placement compartment, and the battery compartment are merely examples for description. In some other embodiments, the battery compartment may not be disposed between the first placement compartment and the second placement compartment, but is disposed at a location close to the side frame 121.

In the structure shown in FIG. 3, an opening direction of the first placement compartment is the same as an opening direction of the second placement compartment, and is opposite to an opening direction of the battery compartment. In other words, the entire middle frame 120 may be designed into a bow-shaped structure. In this way, rigidity of the middle frame 120 and the entire electronic device 100 can be improved, and product reliability can be improved. It should be understood that the battery compartment is a part of the first accommodating cavity, and the first placement compartment and the second placement compartment are a part of the second accommodating cavity.

For example, as shown in FIG. 2 or FIG. 3, the battery 150 may be disposed in the first accommodating cavity, that is, the battery 150 may be disposed in the accommodating space enclosed by the middle frame 120 and the display 110. Specifically, the battery 150 may be disposed in the battery compartment. The circuit board 160 includes a mainboard 161 and a secondary board 162. The mainboard 161 may be received in the first placement compartment, and the secondary board 162 may be placed in the second placement compartment. The mainboard 161 may be fastened to the connection plate 122 in the first placement compartment with a screw, and the secondary board 162 may be fastened to the connection plate 122 in the second placement compartment with a screw as well.

It should be noted that the circuit board 160 (including the mainboard 161 and the secondary board 162) in this application may be a printed circuit board (PCB), or another circuit board. This is not limited in this application. Generally, electronic elements such as a processor, a memory, a flash memory, and a sensor are integrated on the mainboard 161. A charging chip is generally integrated on the secondary board 162, and is configured to manage a power supply of the electronic device.

In the electronic device 100, the battery 150 is configured to supply power to electronic elements on the circuit board 160. The opening direction of the battery compartment is opposite to the opening direction of the first placement compartment or the second placement compartment. Therefore, a hole needs to be drilled between the battery compartment that houses the battery 150 and the first placement compartment that houses the mainboard 161 (or the second placement compartment that houses the secondary board 162), allowing a connector of the battery 150 to pass through the hole to be connected to the mainboard 161 (or the secondary board 162). For example, as shown in FIG. 3, the top of the first placement compartment is provided with a connection opening 1221, and the connection opening 1221 is disposed close to the battery compartment, to reduce a length of a connection line between the battery 150 and the mainboard 161. In other words, the connector on the battery 150 may pass through the connection opening 1221 at the top of the first placement compartment to be connected to the mainboard 161 in the first placement compartment.

In addition, the connection opening may be disposed at another location. For example, a side edge of the first placement compartment is provided with the connection opening, and the battery compartment may directly communicate with the first placement compartment through the connection opening. The connector on the battery 150 may pass through the connection opening provided on the side edge to be connected to the mainboard 161 in the first placement compartment. A specific location of disposing the connection opening needs to be determined based on a location of the connector on the battery 150. For example, if the connector is disposed at the bottom of the battery 150, the connection opening may be provided on a side edge that is of the battery compartment and the first placement compartment and that is close to the bottom of the battery compartment.

In some embodiments, when the battery 150 is placed in the battery compartment, a location of the connector on the battery 150 may be basically flush with a location of the connection opening 1221, so that the connector can directly pass through the connection opening 1221 linearly to be connected to the mainboard 161 in the first placement compartment, so as to make connection between the battery 150 and the mainboard 161 simpler and more convenient. A size of the connection opening 1221 may be set based on a size of the connector, and is generally set to be slightly greater than the connector.

The bracket 170 includes a main bracket 171 and a secondary bracket 172. The main bracket 171 may be placed in the first placement compartment, is located on a side that is of the mainboard 161 and that is away from the display 110, and may be configured to support the mainboard 161 and an antenna located in the first placement compartment. The secondary bracket 172 may be placed in the second placement compartment, is located on a side that is of the secondary board 162 and that is away from the display 110, and may be configured to support the secondary board 162 and an antenna located in the second placement compartment.

The antenna 180 may be deployed in the second accommodating cavity, that is, deployed in an accommodating space enclosed by the middle frame 120 and the back cover 130. To deploy the antenna 180 over a large area, in this embodiment of this application, the antenna 180 may be deployed in the first placement compartment, the second placement compartment, and a corresponding area of the battery compartment, to improve antenna radio frequency performance of the electronic device 100. It should be noted that, in some other embodiments, to deploy the antenna 180 over a large area and enhance antenna radio frequency performance, the antenna 180 may be laid over the entire surface of the second accommodating cavity, that is, the antenna 180 is laid over the entire surface between the middle frame 120 and the back cover 130.

For example, the antenna 180 may include a first antenna 181, a second antenna 182, and a third antenna 183. The first antenna 181 may be deployed in the corresponding area of the battery compartment, and the corresponding area of the battery compartment may be understood as an area in which a projection of the first antenna 181 along a direction z overlaps a projection of the battery compartment along the direction z. In other words, the first antenna 181 may be deployed between the connection plate 122 and the back cover 130, and the projection of the first antenna 181 on the back cover 130 along the direction z at least partially overlaps the projection of the battery compartment (or the battery 150) on the back cover 130 along the direction z. The direction z is a thickness direction of the electronic device 100.

The second antenna 182 may be deployed in the first placement compartment, and may be located on a side that is of the main bracket 171 and that is away from the display 110. For example, the second antenna 182 may be fastened to the main bracket 171. A projection of the second antenna 182 on the back cover 130 in a first direction (namely, the direction z) at least partially overlaps a projection of the first placement compartment on the back cover 130 along the first direction.

The third antenna 183 may be deployed in the second placement compartment, and may be located on a side that is of the secondary bracket 172 and that is away from the display 110. For example, the third antenna 183 may be fastened to the secondary bracket 172. A projection of the third antenna 183 on the back cover 130 along the first direction at least partially overlaps a projection of the second placement compartment on the back cover 130 along the first direction.

For example, the side frame 121 may directly use a metal material as an antenna radiator. In other words, the side frame 121 may be a metal side frame, and the metal side frame may be used as the antenna radiator. It should be understood that, in some embodiments, the second antenna 182 and the third antenna 183 may not be disposed, but the metal side frame is directly used as an antenna radiator. In other words, the side frame 121 may be a metal side frame, and the metal side frame may be used as the antenna radiator. In some other embodiments, the electronic device may alternatively use the metal side frame as an antenna radiator when the second antenna 182 and/or the third antenna 183 are/is disposed. This is not limited in this application.

In some embodiments, the antenna 180 may include only the first antenna 181. The first antenna 181 may be deployed in the corresponding area of the battery compartment. In other words, the first antenna 181 is deployed between the connection plate 122 and the back cover 130, and the projection of the first antenna 181 on the back cover 130 along the direction z overlaps the projection of the battery compartment (or the battery 150) on the back cover 130 along the direction z. It should be understood that, considering that a range of an area of the battery is large, an antenna is deployed in the area of the battery, so that a deployment area of the antenna can be expanded, and antenna radio frequency performance of the electronic device can be improved.

In some embodiments, the middle frame 120 may be a non-metal middle frame. For example, the middle frame 120 is a plastic middle frame. The first antenna 181 may be located on a surface that is of the connection plate 122 and that is away from the battery 150, and along the first direction (namely, the direction z), a distance between the first antenna 181 and the battery 150 is greater than or equal to a first threshold. The projection of the first antenna 181 on the back cover 130 along the first direction at least partially overlaps the projection of the battery 150 on the back cover 130 along the first direction. It should be understood that the first antenna 181 is disposed on the surface that is of the connection plate 122 and that is away from the battery 150, to facilitate assembly and maintenance of the first antenna 181. In addition, considering that a specific distance needs to be maintained between the first antenna 181 and the battery 150, the first antenna 181 is disposed on the surface that is of the connection plate 122 and that is away from the battery 150, so that a thickness of the electronic device can also be reduced. In some other embodiments, the first antenna 181 may alternatively be located on a surface that is of the connection plate 122 and that is close to the battery 150, and a specific distance (for example, the first threshold) also needs to be maintained between the battery 150 and the first antenna 181, and the projection of the first antenna 181 on the back cover 130 along the first direction at least partially overlaps the projection of the battery 150 on the back cover 130 along the first direction. Therefore, in this case, the thickness of the electronic device may increase to some extent.

For example, the first threshold may be at least 0.2 mm, that is, a clearance threshold of the antenna may be at least 0.2 mm. It should be noted that the first threshold is related to a frequency. For example, when millimeter waves are used, the first threshold may be 0.2 mm.

It should be noted that a space range at least 0.2 mm needs to be maintained between the first antenna 181 and the battery 150, and the space range may be a cavity or filled with a non-metal material.

In an example, the first antenna 181 is formed by disposing (applying) a copper foil, a flexible circuit board (FPC), or a steel sheet on the surface that is of the non-metal middle frame and away from the battery 150. In other words, the copper foil, the FPC, or the steel sheet may be attached to the surface that is of the non-metal middle frame and that is away from the battery, to form the antenna radiator.

It should be understood that the FPC antenna is foldable and may be bent into any shape, to meet a higher requirement of people for a size and a design of the electronic device. Therefore, in practice, the FPC antenna made of a liquid crystal polymer (LCP) material with a good high-frequency characteristic may be adopted.

In another example, the first antenna 181 is a metal antenna formed by performing laser direct structuring (LDS), electroplating, or spraying on the surface that is of the non-metal middle frame and that is away from the battery 150. In other words, a metal antenna radiator may be formed on the surface that is of the non-metal middle frame and that is away from the battery 150 by using an LDS technology, an electroplating technology, a spraying technology, or the like.

Considering higher requirements on precision and reliability of an antenna in 5G, the LDS antenna technology has become a preferred solution for an antenna design of the electronic device (like the mobile phone). In the LDS technology, a metal antenna shape is directly plated on a formed plastic bracket through laser radiation. This technology avoids electromagnetic interference of internal components of the mobile phone, ensures a signal of the mobile phone, and also enhances space utilization of the mobile phone, so that the smartphone can still be kept thin in the 5G era.

It should be noted that, in an example, the first antenna 181 may extend to an area in which the mainboard 161 is located and is connected to the mainboard 161. In another example, the first antenna 181 may extend to an area in which the secondary board 162 is located and is connected to the secondary board 162. In still another example, one end of the first antenna 181 may extend to an area in which the mainboard 161 is located and is connected to the mainboard 161, and the other end of the first antenna 181 may extend to an area in which the secondary board 162 is located and is connected to the secondary board 162.

In some embodiments, the first antenna 181 may be connected to the mainboard 161 and/or the secondary board 162 via a spring plate; or the first antenna 181 (for example, the FPC antenna) is bendable, so that the first antenna 181 can be connected to the mainboard 161 and/or the secondary board 162. In some embodiments, a hole may be drilled in the first placement compartment, the second placement compartment, or the battery compartment, so that the first antenna 181 can pass through the connection plate 122 of the middle frame 120, to be connected to the mainboard 161 located in the first placement compartment and/or the secondary board 162 located in the second placement compartment.

It should be understood that the second antenna 182 and the third antenna 183 may also be connected to the mainboard 161 and/or the secondary board 162 in a similar manner.

When the electronic device 100 adopts the architecture shown in FIG. 3, only an opening of the battery compartment faces the display 110, and openings of the first placement compartment and the second placement compartment both face the back cover 130. Therefore, the display 110 needs to be removed only when an electronic component in the battery compartment needs to be repaired or replaced. When another electronic element in the electronic device 100 is faulty, the openings of the first placement compartment and the second placement compartment can be opened by only opening the back cover 130, so that the internal electronic element of the electronic device 100 can be conveniently replaced or repaired. Generally, only the battery 150 is placed in the battery compartment, the battery 150 has a long service life, and the battery 150 is replaced at a low frequency. To be specific, generally, there is a low probability that the display 110 needs to be removed, the electronic device 100 is generally faulty due to problems of other electronic elements, and these electronic elements are mostly disposed in the first placement compartment and the second placement compartment. Therefore, when the electronic device 100 is faulty, the back cover 130 can be removed to check and repair most faults of the electronic device 100. Compared with removing the display 110 from the middle frame 120, removing the back cover 130 is simpler and more convenient.

In addition, the antenna 180 may be laid over most of the area of the second accommodating cavity, that is, the antenna 180 may be deployed in the first placement compartment, the corresponding area of the battery compartment, and the second placement compartment, to improve antenna radio frequency performance of the electronic device 100. In addition, the entire middle frame 120 may be designed into a bow-shaped structure. In this way, rigidity of the middle frame 120 and the entire electronic device 100 can be improved, and product reliability can be improved.

FIG. 4 is a diagram of a cross-sectional structure of another electronic device according to an embodiment of this application. An opening direction of a second placement compartment of the electronic device shown in FIG. 4 is different from that of the electronic device shown in FIG. 3. Consequently, architectures of the entire electronic devices are different.

In the structure shown in FIG. 4, an opening direction of a first placement compartment is different from the opening direction of the second placement compartment, the opening direction of the second placement compartment is the same as an opening direction of a battery compartment, and both the opening direction of the battery compartment and the opening direction of the second placement compartment face the display 110.

As shown in FIG. 4, the middle frame 120 may include the side frame 121 and the connection plate 122, and the connection plate 122 is of a concave-convex structure. Specifically, a middle part of the connection plate 122 may be concave downward, to form the battery compartment. A part that is of the connection plate 122 and that is close to the side frame 121 may be concave downward, to form the second placement compartment. The battery compartment and the second placement compartment may be separated by the connection plate 122, so that the battery compartment and the second placement compartment have relatively independent spaces. The first placement compartment is formed between another side edge of the battery compartment and the side frame 121. The battery compartment is configured for placement of the battery 150, and the first placement compartment and the second placement compartment are configured for placement of other electronic elements, for example, the circuit board 160, the bracket 170, and the antenna 180. It should be understood that the battery compartment and the second placement compartment are a part of a first accommodating cavity, and the first placement compartment is a part of a second accommodating cavity.

For example, the battery 150 may be disposed in the first accommodating cavity, that is, the battery 150 may be disposed in an accommodating space enclosed by the middle frame 120 and the display 110. Specifically, the battery 150 may be disposed in the battery compartment. The circuit board 160 includes the mainboard 161 and the secondary board 162. The mainboard 161 may be received in the first placement compartment, and the secondary board 162 may be placed in the second placement compartment. The mainboard 161 may be fastened to the connection plate 122 in the first placement compartment through a screw, and the secondary board 162 may be fastened to the connection plate 122 in the second placement compartment through a screw as well.

The bracket 170 may be fastened to the middle frame 120. The bracket 170 includes the main bracket 171 and the secondary bracket 172. The main bracket 171 may be located in the first placement compartment. The main bracket 171 is located on a side that is of the mainboard 161 and that is away from the display 110, and may be configured to support the mainboard 161 and an antenna (for example, the second antenna 182) located in the first placement compartment. The secondary bracket 172 may be located in the second placement compartment, and the secondary bracket 172 is located on a side that is of the secondary board 162 and that is close to the display 110, and may be configured to support the secondary board 162.

The antenna 180 may be deployed in the second accommodating cavity, that is, deployed in an accommodating space enclosed by the middle frame 120 and the back cover 130. To deploy the antenna 180 over a large area, in this embodiment of this application, the antenna 180 may be deployed in the first placement compartment, a corresponding area of the second placement compartment, and a corresponding area of the battery compartment, to improve antenna radio frequency performance of the electronic device 100. It should be noted that, in some other embodiments, to deploy the antenna 180 over a large area and enhance antenna radio frequency performance, the antenna 180 may be laid over the entire surface of the second accommodating cavity, that is, the antenna 180 is laid over the entire surface between the middle frame 120 and the back cover 130.

For example, the antenna 180 may include the first antenna 181, the second antenna 182, and the third antenna 183. The first antenna 181 may be deployed in the corresponding area of the battery compartment, and the corresponding area of the battery compartment may be understood as an area in which a projection of the first antenna 181 along a direction z overlaps a projection of the battery compartment along the direction z. In other words, the first antenna 181 is deployed between the connection plate 122 and the back cover 130, and the projection of the first antenna 181 on the back cover 130 along the direction z at least partially overlaps the projection of the battery compartment (or the battery 150) on the back cover 130 along the direction z. The direction z is a thickness direction of the electronic device 100.

The second antenna 182 may be deployed in the first placement compartment, and may be located on a side that is of the main bracket 171 and that is away from the display 110. For example, the second antenna 182 may be fastened to the main bracket 171. A projection of the second antenna 182 on the back cover 130 along the first direction (namely, the direction z) at least partially overlaps a projection of the first placement compartment on the back cover 130 along the first direction.

The third antenna 183 may be deployed in the corresponding area of the second placement compartment, and the corresponding area of the second placement compartment may be understood as an area in which a projection that is of the third antenna 183 and that is in the direction z overlaps a projection that is of the second placement compartment and that is in the direction z. In addition, the third antenna 183 may be located between the middle frame 120 and the back cover 130. For example, the third antenna 183 may be fastened to a surface that is of the middle frame 120 and that is away from the display 110. The projection of the third antenna 183 on the back cover 130 along the first direction at least partially overlaps the projection of the second placement compartment on the back cover 130 along the first direction.

It should be understood that the foregoing mainly describes a difference between the electronic device shown in FIG. 4 and the electronic device shown in FIG. 3, and same content of the two is not described again.

When the electronic device 100 adopts the architecture shown in FIG. 4, the antenna 180 may be laid over most of the area of the second accommodating cavity, that is, the antenna 180 may be deployed in a corresponding area of the first placement compartment, the corresponding area of the battery compartment, and the corresponding area of the second placement compartment, to improve antenna radio frequency performance of the electronic device 100. In addition, the connection plate 122 of the middle frame 120 is of a concave-convex structure, which can also improve rigidity of the middle frame 120 and the entire electronic device 100 to some extent, and improve product reliability.

FIG. 5 is a diagram of a cross-sectional structure of another electronic device according to an embodiment of this application. An opening direction of a first placement compartment of the electronic device shown in FIG. 5 is different from that of the electronic device shown in FIG. 3. Consequently, architectures of the entire electronic devices are different.

Specifically, in the structure shown in FIG. 5, the opening direction of the first placement compartment is different from an opening direction of a second placement compartment, the opening direction of the first placement compartment is the same as an opening direction of a battery compartment, and both the opening direction of the battery compartment and the opening direction of the first placement compartment face the display 110.

As shown in FIG. 5, the middle frame 120 may include the side frame 121 and the connection plate 122, and the connection plate 122 is of a concave-convex structure. Specifically, a middle part of the connection plate 122 may be concave downward, to form the battery compartment. A part that is of the connection plate 122 and that is close to the side frame 121 may be concave downward, to form the first placement compartment. The battery compartment and the first placement compartment may be separated by the connection plate 122, so that the battery compartment and the first placement compartment have relatively independent spaces. The second placement compartment is formed between another side edge of the battery compartment and the side frame 121. The battery compartment is configured for placement of the battery 150, and the first placement compartment and the second placement compartment are configured for placement of other electronic elements, for example, the circuit board 160, the bracket 170, and the antenna 180. It should be understood that the battery compartment and the first placement compartment are a part of a first accommodating cavity, and the second placement compartment is a part of a second accommodating cavity.

For example, the battery 150 may be disposed in the first accommodating cavity, that is, the battery 150 may be disposed in an accommodating space enclosed by the middle frame 120 and the display 110. Specifically, the battery 150 may be disposed in the battery compartment. The circuit board 160 includes the mainboard 161 and the secondary board 162. The mainboard 161 may be received in the first placement compartment, and the secondary board 162 may be placed in the second placement compartment. The mainboard 161 may be fastened to the connection plate 122 in the first placement compartment through a screw, and the secondary board 162 may be fastened to the connection plate 122 in the second placement compartment through a screw as well.

The bracket 170 includes the main bracket 171 and the secondary bracket 172. The main bracket 171 may be located in the first placement compartment. The main bracket 171 may be located on a side that is of the mainboard 161 and that is close to the display 110, and may be configured to support the mainboard 161. The secondary bracket 172 may be located in the second placement compartment. The secondary bracket 172 may be located on a side that is of the secondary board 162 and that is close to the display 110, and may be configured to support the secondary board 162 and an antenna (for example, the third antenna 183) located in the second placement compartment.

The antenna 180 may be deployed in the second accommodating cavity, that is, deployed in an accommodating space enclosed by the middle frame 120 and the back cover 130. To deploy the antenna 180 over a large area, in this embodiment of this application, the antenna 180 may be deployed in a corresponding area of the first placement compartment, the second placement compartment, and a corresponding area of the battery compartment, to improve antenna radio frequency performance of the electronic device 100. It should be noted that, in some other embodiments, to deploy the antenna 180 over a large area and enhance antenna radio frequency performance, the antenna 180 may be laid over the entire surface of the second accommodating cavity, that is, the antenna 180 is laid over the entire surface between the middle frame 120 and the back cover 130.

For example, the antenna 180 may include the first antenna 181, the second antenna 182, and the third antenna 183. The first antenna 181 may be deployed in the corresponding area of the battery compartment, and the corresponding area of the battery compartment may be understood as an area in which a projection that is of the first antenna 181 and that is in a direction z overlaps a projection that is of the battery compartment and that is in the direction z. In other words, the first antenna 181 is deployed between the connection plate 122 and the back cover 130, and the projection of the first antenna 181 on the back cover 130 along the direction z at least partially overlaps the projection of the battery compartment on the back cover 130 along the direction z. The direction z is a thickness direction of the electronic device 100.

The second antenna 182 may be deployed in the corresponding area of the first placement compartment, and the corresponding area of the first placement compartment may be understood as an area in which a projection that is of the second antenna 182 and that is in the direction z overlaps a projection that is of the first placement compartment and that is in the direction z. In addition, the second antenna 182 may be located on a side that is of the middle frame 120 and that is away from the display 110. For example, the second antenna 182 may be attached to a surface that is of the middle frame 120 and that is away from the display 110. The projection of the second antenna 182 on the back cover 130 along the first direction (namely, the direction z) at least partially overlaps the projection of the first placement compartment on the back cover 130 along the first direction.

The third antenna 183 may be deployed in the second placement compartment, and may be located on a side that is of the secondary bracket 172 and that is away from the display 110. For example, the third antenna 183 may be fastened to the secondary bracket 172. A projection of the third antenna 183 on the back cover 130 along the first direction at least partially overlaps a projection of the second placement compartment on the back cover 130 along the first direction.

It should be understood that the foregoing mainly describes a difference between the electronic device shown in FIG. 5 and the electronic device shown in FIG. 3, and same content of the two is not described again.

When the electronic device 100 adopts the architecture shown in FIG. 5, the antenna 180 may be laid over most of the area of the second accommodating cavity, that is, the antenna 180 may be deployed in the corresponding area of the first placement compartment, the corresponding area of the battery compartment, and the second placement compartment, to improve antenna radio frequency performance of the electronic device 100. In addition, the connection plate 122 of the middle frame 120 is of a concave-convex structure, which can also improve rigidity of the middle frame 120 and the entire electronic device 100 to some extent, and improve product reliability.

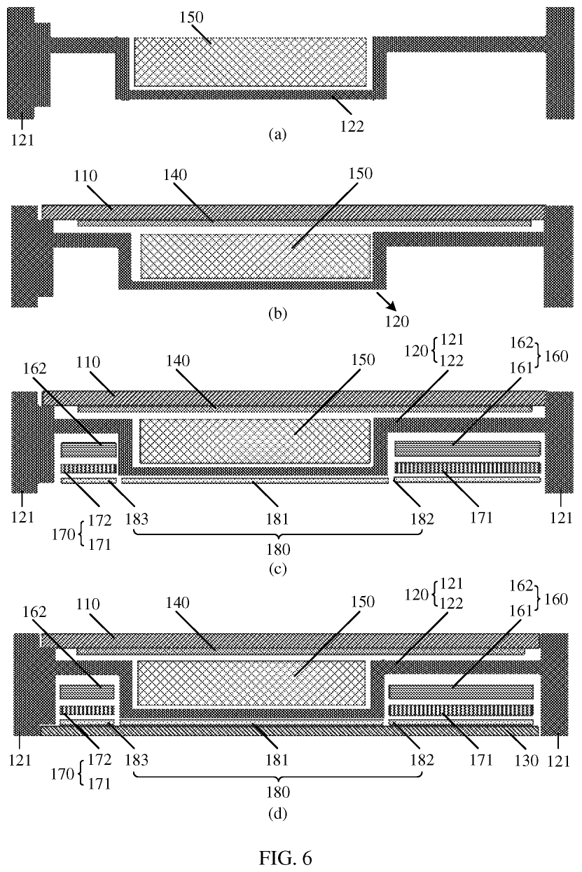

FIG. 6 is a diagram of an assembly process of the electronic device shown in FIG. 3. First, as shown in (a) in FIG. 6, the battery 150 may be mounted in the battery compartment of the first accommodating cavity, that is, the battery 150 may be mounted at a location close to the middle frame T surface. Second, as shown in (b) in FIG. 6, a screen component may be mounted in the first accommodating cavity, that is, the screen component may be mounted at a location close to the middle frame T surface. The screen component may include the display 110 and the heat dissipation module 140. Third, as shown in (c) in FIG. 6, electronic elements (for example, the circuit board 160, the bracket 170, and the antenna 180) may be mounted in the second accommodating cavity. Specifically, the mainboard 161, the main bracket 171, and the second antenna 182 may be placed in the first placement compartment, the secondary board 162, the secondary bracket 172, and the third antenna 183 may be placed in the second placement compartment, and the first antenna 181 is disposed in the corresponding area of the battery compartment. Finally, as shown in (d) in FIG. 6, the back cover 130 may be mounted at a location close to the middle frame B surface, that is, the back cover 130 is mounted to a side that is of the antenna 180 and that is away from the display 110, and a side edge of the back cover 130 is fastened to the side frame 121 of the middle frame 120.

It can be learned from the assembly process of the electronic device 100 that the battery 150 is mounted in the battery compartment, an opening of the battery compartment faces the display 110, most electronic elements of the electronic device 100 are mounted in the first placement compartment and the second placement compartment, and openings of the first placement compartment and the second placement compartment both face the back cover 130. However, the battery 150 has a long service life and a low replacement frequency. Therefore, when another electronic element in the electronic device 100 is faulty, the openings of the first placement compartment and the second placement compartment can be opened by opening the back cover 130, so that the internal electronic element of the electronic device 100 can be conveniently replaced or repaired, and an operation is convenient and simple.

In addition, the antenna 180 may be deployed in a corresponding area of the first placement compartment, the corresponding area of the battery compartment, and a corresponding area of the second placement compartment, so that a deployment area of the antenna 180 can be expanded, and antenna radio frequency performance of the electronic device 100 can be improved. In addition, the entire middle frame 120 is designed into a bow-shaped structure. In this way, rigidity of the middle frame 120 and the entire electronic device 100 can be improved, and product reliability can be improved.

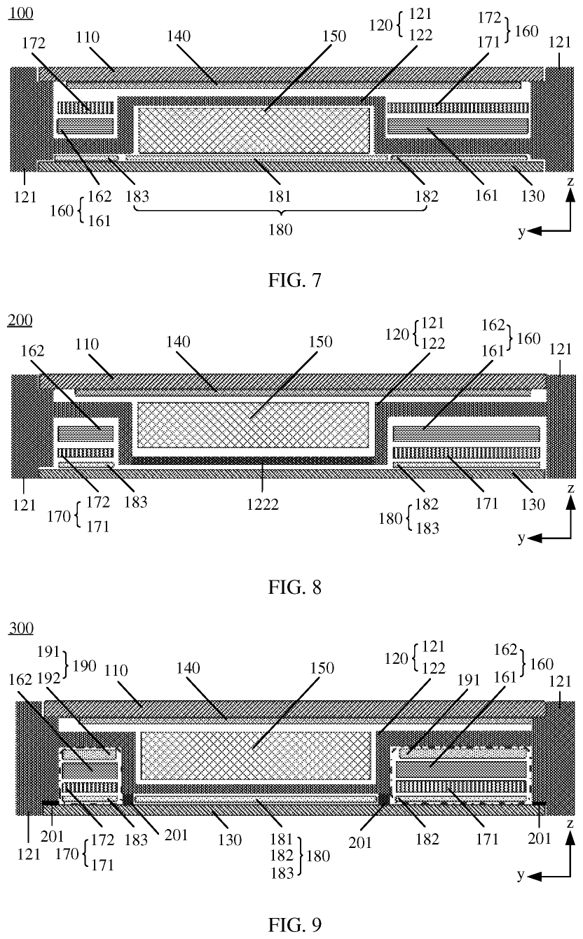

FIG. 7 is a diagram of a cross-sectional structure of another electronic device according to an embodiment of this application. Opening directions of a battery compartment, a first placement compartment, and a second placement compartment of the electronic device shown in FIG. 7 are all different from these of the electronic device shown in FIG. 3. Consequently, architectures of the entire electronic devices are different.

Specifically, in the structure shown in FIG. 7, the opening direction of the first placement compartment is the same as the opening direction of the second placement compartment, and the opening direction of the first placement compartment and the opening direction of the second placement compartment are different from the opening direction of the battery compartment. An opening of the battery compartment faces the back cover 130, an opening of the second placement compartment faces the display 110, and an opening of the second placement compartment also faces the display 110.

As shown in FIG. 7, the middle frame 120 may include the side frame 121 and the connection plate 122, and the connection plate 122 is of a concave-convex structure. Specifically, a middle part of the connection plate 122 may protrude upward, that is, protrude toward the display 110, to form the battery compartment. Because the connection plate 122 is connected to and inside the side frame 121, side walls on two sides of the battery compartment and the side frame 121 form the first placement compartment and the second placement compartment. The battery compartment is configured for placement of the battery 150, and the first placement compartment and the second placement compartment are configured for placement of other electronic elements, for example, the circuit board 160, the bracket 170, and the antenna 180. It should be understood that the first placement compartment and the second placement compartment are a part of a first accommodating cavity, and the battery compartment is a part of a second accommodating cavity.

For example, the battery 150 may be disposed in the second accommodating cavity, that is, the battery 150 may be disposed in an accommodating space enclosed by the middle frame 120 and the back cover 130. Specifically, the battery 150 may be disposed in the battery compartment. The circuit board 160 includes the mainboard 161 and the secondary board 162. The mainboard 161 may be received in the first placement compartment, and the secondary board 162 may be placed in the second placement compartment. The mainboard 161 may be fastened to the connection plate 122 in the first placement compartment through a screw, and the secondary board 162 may be fastened to the connection plate 122 in the second placement compartment through a screw as well.

The bracket 170 includes the main bracket 171 and the secondary bracket 172. The main bracket 171 may be located in the first placement compartment. The main bracket 171 is located on a side that is of the mainboard 161 and that is away from the display 110, and may be configured to support the mainboard 161. The secondary bracket 172 may be located in the second placement compartment. The secondary bracket 172 is located on a side that is of the secondary board 162 and that is away from the display 110, and may be configured to support the secondary board 162.

The antenna 180 may be deployed in the second accommodating cavity, that is, deployed in an accommodating space enclosed by the middle frame 120 and the back cover 130. To deploy the antenna 180 over a large area, in this embodiment of this application, the antenna 180 may be deployed in a corresponding area of the first placement compartment, a corresponding area of the second placement compartment, and a corresponding area of the battery compartment, to improve antenna radio frequency performance of the electronic device 100. It should be noted that, in some other embodiments, to deploy the antenna 180 over a large area and enhance antenna radio frequency performance, the antenna 180 may be laid over the entire surface of the second accommodating cavity, that is, the antenna 180 is laid over the entire surface between the middle frame 120 and the back cover 130.

For example, the antenna 180 may include the second antenna 182, the third antenna 183, and the first antenna 181. The first antenna 181 may be deployed in the battery compartment, and the first antenna 181 may be located between the battery 150 and the back cover 130. A projection of the first antenna 181 on the back cover 130 along a direction z at least partially overlaps a projection of the battery compartment (or the battery 150) on the back cover 130 along the direction z.

The second antenna 182 may be deployed in the corresponding area of the first placement compartment, and the corresponding area of the first placement compartment may be understood as an area in which a projection that is of the second antenna 182 and that is in the direction z overlaps a projection that is of the first placement compartment and that is in the direction z. In addition, the second antenna 182 may be located between the connection plate 122 and the back cover 130. For example, the second antenna 182 may be fastened to a surface that is of the middle frame 120 and that is away from the display 110. The projection of the second antenna 182 on the back cover 130 in the direction z at least partially overlaps the projection of the first placement compartment on the back cover 130 in the direction z.

The third antenna 183 may be deployed in the corresponding area of the second placement compartment, and the corresponding area of the second placement compartment may be understood as an area in which a projection that is of the third antenna 183 and that is in the direction z overlaps a projection that is of the second placement compartment and that is in the direction z. In addition, the third antenna 183 may be deployed between the connection plate 122 and the back cover 130. For example, the third antenna 183 may be fastened to a surface that is of the middle frame 120 and that is away from the display 110. The projection of the third antenna 183 on the back cover 130 in the direction z at least partially overlaps the projection of the second placement compartment on the back cover 130 in the direction z.

For example, the side frame 121 may directly use a metal material as an antenna radiator. In other words, the side frame 121 may be a metal side frame, and the metal side frame may be used as the antenna radiator. It should be understood that, in some embodiments, the second antenna 182 and the third antenna 183 may not be disposed, but the metal side frame is directly used as an antenna radiator. In other words, the side frame 121 may be a metal side frame, and the metal side frame may be used as the antenna radiator. In some other embodiments, the electronic device may alternatively use the metal side frame as an antenna radiator when the second antenna 182 and/or the third antenna 183 are/is disposed. This is not limited in this application.

In some embodiments, the antenna 180 may include only the first antenna 181. The first antenna 181 may be deployed in the corresponding area of the battery compartment, and the corresponding area of the battery compartment may be understood as an area in which the projection that is of the first antenna 181 and that is in the direction z overlaps the projection that is of the battery compartment and that is in the direction z. In other words, the first antenna 181 may be deployed between the battery 150 and the back cover 130, and the projection of the first antenna 181 on the back cover 130 along the direction z overlaps the projection of the battery compartment (or the battery 150) on the back cover 130 along the direction z. It should be understood that, considering that a range of an area of the battery is large, an antenna is deployed in the area of the battery, so that a deployment area of the antenna can be expanded, and antenna radio frequency performance of the electronic device can be improved.

It should be noted that, along the first direction (namely, the direction z), a distance between the first antenna 181 and the battery 150 is greater than or equal to a first threshold.

For example, the first threshold may be at least 0.2 mm, that is, a clearance threshold of the antenna may be at least 0.2 mm. It should be noted that the first threshold is related to a frequency. For example, when millimeter waves are used, the first threshold may be 0.2 mm.

It should be noted that a space range at least 0.2 mm needs to be maintained between the first antenna 181 and the battery 150, and the space range may be a cavity or filled with a non-metal material.

In some embodiments, an antenna bracket is disposed between the first antenna 181 and the back cover 130. The antenna bracket is connected to the back cover 130 or the middle frame 120, and the antenna bracket is configured to support the first antenna 181.

It should be understood that the foregoing mainly describes a difference between the electronic device shown in FIG. 7 and the electronic device shown in FIG. 3, and same content of the two is not described again.

When the electronic device adopts the architecture shown in FIG. 7, the antenna 180 may be laid over most of the area of the second accommodating cavity, that is, the antenna 180 may be deployed in the corresponding area of the first placement compartment, the corresponding area of the battery compartment, and the corresponding area of the second placement compartment, to improve antenna radio frequency performance of the electronic device 100. In addition, the entire middle frame 120 may be designed into a bow-shaped structure. In this way, rigidity of the middle frame 120 and the entire electronic device 100 can be improved, and product reliability can be improved.

It should be noted that, in some other design architectures, the opening of the battery compartment may face the back cover 130, the opening of the first placement compartment may face the display 110, and the opening of the second placement compartment may face the back cover 130; or the opening of the battery compartment may face the back cover 130, the opening of the first placement compartment may face the back cover 130, and the opening of the second placement compartment may face the display 110; or the openings of the first placement compartment, the second placement compartment, and the battery compartment may all face the display 110; or the openings of the first placement compartment, the second placement compartment, and the battery compartment may all face the back cover 130. This is not limited in this application.

FIG. 8 is a diagram of a cross-sectional structure of another electronic device 200 according to an embodiment of this application. A deployment manner of the first antenna 181 of the electronic device 200 shown in FIG. 8 is different from that of the electronic device 100 shown in FIG. 3. In the electronic device 200 shown in FIG. 8, the first antenna 181 is not separately disposed, but a metal middle frame is used to form an antenna radiator. The following provides specific descriptions with reference to FIG. 8.

As shown in FIG. 8, the electronic device 200 may include the display 110, the middle frame 120, the back cover 130, and the battery 150. The middle frame 120 is located between the display 110 and the back cover 130. The middle frame 120 includes the connection plate 122 and the side frame 121 disposed around the connection plate 122. The connection plate 122 is provided with a battery compartment, and the battery compartment is configured for placement of the battery 150.

A first part (denoted as 1222) of the connection plate 122 may be made of a metal material, the first part 1222 of the connection plate 122 is an antenna radiator, a projection of the first part 1222 of the connection plate 122 on the back cover 130 along a first direction at least partially overlaps a projection of the battery 150 on the back cover 130 along the first direction, and the first direction (namely, a direction z) is a thickness direction of the electronic device 200.

It should be understood that, in this application, the connection plate 122 corresponding to the battery 150 may be set to a metal material, so that the connection plate 122 made of the metal material may be directly used as the antenna radiator, and an antenna does not need to be separately disposed.

The “connection plate 122 corresponding to the battery 150” may be understood as the first part 1222 of the connection plate 122, and the projection of the first part 1222 of the connection plate 122 on the back cover 130 along the direction z at least partially overlaps the projection of the battery 150 on the back cover 130 along the direction z.

In this embodiment of this application, considering that a range of an area of the battery 150 is large, an antenna is deployed in the area of the battery 150, so that a deployment area of the antenna can be expanded, and antenna radio frequency performance of the electronic device can be improved.

In some embodiments, along the first direction (namely, the direction z), a distance between the metal connection plate (namely, the first part 1222 of the connection plate 122) and the battery 150 is greater than or equal to a first threshold.

For example, the first threshold may be at least 0.2 mm, that is, a clearance threshold of the antenna may be at least 0.2 mm. It should be noted that the first threshold is related to a frequency. For example, when millimeter waves are used, the first threshold may be 0.2 mm.

It should be noted that a space range at least 0.2 mm needs to be maintained between the first part 1222 of the connection plate 122 and the battery 150, and the space range may be a cavity or filled with a non-metal material.

In some embodiments, as shown in FIG. 8, the electronic device 200 may further include the mainboard 161 and the secondary board 162. A first placement compartment and a second placement compartment are disposed on the connection plate 122. The battery compartment is located between the first placement compartment and the second placement compartment. The mainboard 161 is received in the first placement compartment, and the secondary board 162 is placed in the second placement compartment. The first placement compartment and the second placement compartment have a same (i.e., common) opening direction, an opening direction of the battery compartment is opposite to the opening direction of the first placement compartment and the second placement compartment, and an opening of the battery compartment faces the display 110. Both an opening of the first placement compartment and an opening of the second placement compartment face the back cover 130.

In this embodiment, only the opening of the battery compartment faces the display 110, and the openings of the first placement compartment and the second placement compartment both face the back cover 130. Therefore, this facilitates check and maintenance of the electronic component when a fault occurs. In addition, the entire middle frame 120 may be designed into a bow-shaped structure. In this way, rigidity of the middle frame 120 and the entire electronic device can be improved, and product reliability can be improved.

In some other embodiments, the first placement compartment and the second placement compartment have a same (i.e., common) opening direction, and an opening direction of the battery compartment is opposite to the opening direction of the first placement compartment and the second placement compartment. For example, an opening of the battery compartment faces the back cover 130, and an opening of the first placement compartment and an opening of the second placement compartment both face the display 110.

In some other embodiments, the first placement compartment and the second placement compartment have opposite opening directions, and the first placement compartment and the battery compartment have a same (i.e., common) opening directions. For example, an opening of the battery compartment faces the display 110, an opening of the first placement compartment faces the display 110, and an opening of the second placement compartment faces the back cover 130.

In some other embodiments, the first placement compartment and the second placement compartment have opposite opening directions, and the first placement compartment and the battery compartment have a same opening directions. For example, an opening of the battery compartment faces the back cover 130, an opening of the first placement compartment faces the back cover 130, and an opening of the second placement compartment faces the display 110.

In some other embodiments, the first placement compartment and the second placement compartment have opposite opening directions, and the second placement compartment and the battery compartment have a same opening directions. For example, an opening of the battery compartment faces the display 110, an opening of the first placement compartment faces the back cover 130, and an opening of the second placement compartment faces the display 110.

In some other embodiments, the first placement compartment and the second placement compartment have opposite opening directions, and the second placement compartment and the battery compartment have a same (i.e., common) opening directions. For example, an opening of the battery compartment faces the back cover 130, an opening of the first placement compartment faces the display 110, and an opening of the second placement compartment faces the back cover 130.

In some other embodiments, opening directions of the first placement compartment, the second placement compartment, and the battery compartment may all be the same. In other words, openings of the first placement compartment, the second placement compartment, and the battery compartment may all face the display 110, or openings of the first placement compartment, the second placement compartment, and the battery compartment may all face the back cover 130. This is not limited in this application.

It should be understood that this embodiment of this application provides design architectures of a plurality of electronic devices (for example, a mobile phone), to enrich a layout manner of internal components of the electronic device, and be applicable to different types of electronic devices.

For example, the connection plate 122 of the middle frame 120 may be of a concave-convex structure, and concave parts or convex parts may form the first placement compartment, the second placement compartment, and the battery compartment. Generally, the first placement compartment and the second placement compartment may be formed in an area enclosed by the connection plate 122 and the side frame 121, and the battery compartment may be located between the first placement compartment and the second placement compartment. In addition, the battery compartment, the first placement compartment, and the second placement compartment may be separated from each other by the connection plate 122.

It should be noted that locations of the first placement compartment, the second placement compartment, and the battery compartment are merely examples for description. In some other embodiments, the battery compartment may not be disposed between the first placement compartment and the second placement compartment, but is disposed at a location close to the side frame 121.

In some embodiments, the electronic device 200 may further include the second antenna 182 and/or the third antenna 183. A projection of the second antenna 182 on the back cover 130 along the first direction at least partially overlaps a projection of the first placement compartment on the back cover 130 along the first direction. A projection of the third antenna 183 on the back cover 130 along the first direction at least partially overlaps a projection of the second placement compartment on the back cover 130 along the first direction.

For example, the second antenna 182 may be placed in the first placement compartment, for example, the second antenna 182 may be fastened to the main bracket 171; and the third antenna 183 may be placed in the second placement compartment, for example, the third antenna 183 may be fastened to the secondary bracket 172.

In some embodiments, the second antenna 182 and/or the third antenna 183 may be connected to the mainboard 161 and/or the secondary board 162 via a spring plate; or the second antenna 182 and/or the third antenna 183 (for example, an FPC antenna) are/is bendable, so that the second antenna 182 and/or the third antenna 183 can be connected to the mainboard 161 and/or the secondary board 162. In some embodiments, a hole may be drilled in the first placement compartment, the second placement compartment, or the battery compartment, so that the second antenna 182 and/or the third antenna 183 can pass through the connection plate 122 of the middle frame 120, to be connected to the mainboard 161 located in the first placement compartment and/or the secondary board 162 located in the second placement compartment.

In some embodiments, the side frame 121 is a metal side frame 121, and the metal side frame 121 is used as an antenna radiator. In this implementation, the side frame 121 may be used as the metal antenna radiator.

It should be understood that, in some examples, the electronic device 200 may not be provided with the second antenna 182 and the third antenna 183, but directly use the metal side frame 121 as an antenna radiator. In some other examples, the electronic device 200 may use the metal side frame 121 as an antenna radiator when the second antenna 182 and/or the third antenna 183 are/is disposed. This is not limited in this application.

It should be noted that, in design architectures of different electronic devices (as shown in FIG. 4 to FIG. 7), a solution in which the first antenna 181 is not disposed and the metal middle frame shown in FIG. 8 is used may be adopted.

FIG. 9 is a diagram of a cross-sectional structure of another electronic device 300 according to an embodiment of this application. It should be understood that FIG. 9 mainly shows a location of a speaker 190 in the electronic device.

As shown in FIG. 9, the electronic device 300 may further include the speaker 190. The speaker 190 may include a first speaker 191 and a second speaker 192. For example, the first speaker 191 is a top speaker, and the second speaker 192 is a bottom speaker.

For example, the first speaker 191 may be disposed in a first placement compartment, and the second speaker 192 may be disposed in a second placement compartment. Both the first placement compartment and the second placement compartment are sealed cavities, and the first placement compartment and the second placement compartment are shown by dashed boxes in FIG. 9. In this example, the first placement compartment and the second placement compartment are set as sealed cavities, so that when the speakers in the first placement compartment and the second placement compartment play music, no strong vibration occurs, and vibration noise generated by a back cover when the electronic device plays music can be reduced.

It should be understood that, to set the first placement compartment and the second placement compartment as sealed cavities, a gap part may be sealed by using a sealing adhesive 201.

It should be noted that the speaker 190 may be disposed in the architectures of the electronic devices shown in FIG. 3 to FIG. 5, FIG. 7, and FIG. 8. For a specific manner of disposing the speaker 190, refer to FIG. 9. Details are not described herein again.

The foregoing descriptions are merely illustrative and are not intended to limit the protection scope of this disclosure. Any variation or replacement readily determinable by a person skilled in the art within the technical scope of this disclosure is intended to fall within the protection scope of the accompanying claims.

What is claimed is:

1. An electronic device, comprising:
a display:
a middle frame;
a back cover;
a battery; and
a first antenna, wherein:
the middle frame is located between the display and the back cover;
the middle frame comprises a connection plate and a side frame disposed around the connection plate;
the connection plate is provided with a battery compartment;
the battery compartment is configured for placement of the battery; and
a projection of the first antenna on the back cover along a first direction at least partially overlaps a projection of the battery on the back cover along the first direction, wherein the first direction is a thickness direction of the electronic device.

2. The electronic device according to claim 1, wherein:
the middle frame is a non-metal middle frame;
the first antenna is located on a surface of the connection plate away from the battery and along the first direction, wherein a distance between the first antenna and the battery is greater than or equal to a first threshold.

3. The electronic device according to claim 2, wherein the first antenna is formed by applying a copper foil, a flexible printed circuit (FPC), or a steel sheet on the surface of the non-metal middle frame and away from the battery.

4. The electronic device according to claim 2, wherein the first antenna is a metal antenna formed by performing laser direct structuring (LDS), electroplating or spray plating on the surface of the non-metal middle frame positioned away from the battery.

5. The electronic device according to claim 1, wherein:
an opening of the battery compartment faces the display; and
the first antenna is located between the connection plate and the back cover.

6. The electronic device according to claim 1, wherein:
an opening of the battery compartment faces the back cover; and
the first antenna is located between the battery and the back cover.

7. The electronic device according to claim 5, wherein:
the electronic device further comprises a mainboard and a secondary board;
a first placement compartment and a second placement compartment are disposed on the connection plate;
the battery compartment is located between the first placement compartment and the second placement compartment;
the mainboard is received in the first placement compartment:
the secondary board is received in the second placement compartment; and
the first placement compartment and the second placement compartment have a common opening direction, and an opening direction of the battery compartment is opposite to the opening direction of the first placement compartment and the second placement compartment.

8. The electronic device according to claim 5, wherein:
the electronic device further comprises a mainboard and a secondary board;
a first placement compartment and a second placement compartment are disposed on the connection plate;
the battery compartment is located between the first placement compartment and the second placement compartment;
the mainboard is received in the first placement compartment;
the secondary board is received in the second placement compartment; and
the first placement compartment and the second placement compartment have opposite opening directions, and the first placement compartment and the battery compartment have a common opening direction.

9. The electronic device according to claim 5, wherein:
the electronic device further comprises a mainboard and a secondary board;
a first placement compartment and a second placement compartment are disposed on the connection plate;
the battery compartment is located between the first placement compartment and the second placement compartment;
the mainboard is received in the first placement compartment;
the secondary board is received in the second placement compartment; and
the first placement compartment and the second placement compartment have opposite opening directions, and the second placement compartment and the battery compartment have a common opening direction.

10. The electronic device according to claim 7, wherein:
the first antenna is connected to the mainboard, and/or the first antenna is connected to the secondary board.

11. The electronic device according to claim 7, further comprising a first speaker and a second speaker, the first speaker is disposed in the first placement compartment, the second speaker is disposed in the second placement compartment, and both the first placement compartment and the second placement compartment are sealed cavities.

12. The electronic device according to claim 7, further comprising a second antenna and a third antenna, a projection of the second antenna on the back cover along the first direction at least partially overlaps a projection of the first placement compartment on the back cover along the first direction, and a projection of the third antenna on the back cover along the first direction at least partially overlaps a projection of the second placement compartment on the back cover along the first direction.

13. The electronic device according to claim 1, wherein the side frame is formed from a metal, and the metal side frame is used as an antenna radiator.

14. An electronic device, comprising:
a display;
a middle frame;
a back cover; and
a battery, wherein:
the middle frame is located between the display and the back cover;
the middle frame comprises a connection plate and a side frame disposed around the connection plate;
the connection plate is provided with a battery compartment;
the battery compartment is configured for receipt of the battery;
a first part of the connection plate is made of a metal material;
the first part of the connection plate is an antenna radiator;
a projection of the first part of the connection plate on the back cover along a first direction at least partially overlaps a projection of the battery on the back cover along the first direction; and
the first direction is a thickness direction of the electronic device.

15. The electronic device according to claim 14, wherein along the first direction, a distance between the first part of the connection plate and the battery is greater than or equal to a first threshold.

16. The electronic device according to claim 14, wherein:
the electronic device further comprises a mainboard and a secondary board;
a first placement compartment and a second placement compartment are disposed on the connection plate;
the battery compartment is located between the first placement compartment and the second placement compartment;
the mainboard is received in the first placement compartment;
the secondary board is received in the second placement compartment;
the first placement compartment and the second placement compartment have a common opening direction;
an opening direction of the battery compartment is opposite to the opening direction of the first placement compartment and the second placement compartment; and
an opening of the battery compartment faces the display or an opening of the battery compartment faces the back cover.

17. The electronic device according to claim 14, wherein:
the electronic device further comprises a mainboard and a secondary board;
a first placement compartment and a second placement compartment are disposed on the connection plate;
the battery compartment is located between the first placement compartment and the second placement compartment;
the mainboard is received in the first placement compartment;
the secondary board is received in the second placement compartment;
the first placement compartment and the second placement compartment have opposite opening directions;
the first placement compartment and the battery compartment have a common opening direction, and
an opening of the battery compartment faces the display or an opening of the battery compartment faces the back cover.

18. The electronic device according to claim 14, wherein:
the electronic device further comprises a mainboard and a secondary board;
a first placement compartment and a second placement compartment are disposed on the connection plate;
the battery compartment is located between the first placement compartment and the second placement compartment;
the mainboard is received in the first placement compartment;
the secondary board is received in the second placement compartment;
the first placement compartment and the second placement compartment have opposite opening directions;
the second placement compartment and the battery compartment have a common opening direction; and
an opening of the battery compartment faces the display or an opening of the battery compartment faces the back cover.

19. The electronic device according to claim 16, further comprising a first speaker and a second speaker, the first speaker is disposed in the first placement compartment, the second speaker is disposed in the second placement compartment, and both the first placement compartment and the second placement compartment are sealed cavities.

20. The electronic device according to claim 16, further comprising a second antenna and a third antenna, a projection of the second antenna on the back cover along the first direction at least partially overlaps a projection of the first placement compartment on the back cover along the first direction, and a projection of the third antenna on the back cover along the first direction at least partially overlaps a projection of the second placement compartment on the back cover along the first direction.
